(19) United States
(12) Patent Application Publication
(10) Pub. No.: US 2023/0420961 A1
(43) Pub. Date: Dec. 28, 2023

(54) CASE FOR PORTABLE ELECTRONIC DEVICES

(71) Applicant: Apple Inc., Cupertino, CA (US)

(72) Inventors: Ivan S. MARIC, Palo Alto, CA (US); Samuel A. RESNICK, San Francisco, CA (US)

(21) Appl. No.: 18/213,146

(22) Filed: Jun. 22, 2023

Related U.S. Application Data
(60) Provisional application No. 63/355,504, filed on Jun. 24, 2022.

(51) Int. Cl. H02J 7/00; H01M 50/247

(52) U.S. Cl. CPC H02J 7/0044; H01M 50/247; H02J 7/00036; H01M 2220/30; H02J 2207/30

(57) ABSTRACT

A case can facilitate operation with a portable electronic device and a battery device that can be connected to another, external device. To minimize the number of separate devices carried by a user, a battery device can be held within the case that also holds the portable electronic device. The case can hold the portable electronic device continually and receive the battery device when the user wants to group the devices together. The battery pack can provide charging power to the external device (e.g., wearable device) while held within the case. The case can provide engagement with the battery device to retain it and/or a communication link to communicate with it.

### CROSS-REFERENCE TO RELATED APPLICATION

This application claims the benefit of U.S. Provisional Application No. 63/355,504, entitled “CASE FOR PORTABLE ELECTRONIC DEVICES,” filed Jun. 24, 2022, the entirety of which is incorporated herein by reference.

### TECHNICAL FIELD

The present description relates generally to cases, and, more particularly, to cases for portable electronic devices.

### BACKGROUND

Portable electronic devices (e.g., wearable devices, mobile phones, media players, electronic watches, and the like) operate when there is charge stored in their batteries. Some portable electronic devices include a rechargeable battery that can be recharged by coupling the portable electronic device to a power source through a physical connection, such as through a charging cord. Using a charging cord to charge a battery in a portable electronic device, however, may require the portable electronic device to be physically tethered to a power outlet.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a perspective view of a system including a portable electronic device, a case, a battery device, and an external device, in accordance with embodiments of the present disclosure.

FIG. 2 illustrates a perspective view of the system of FIG. 1 with the portable electronic device, the case, and the battery device in an assembled configuration, in accordance with embodiments of the present disclosure.

FIG. 3 illustrates a side sectional view of a case, in accordance with embodiments of the present disclosure.

FIG. 4 illustrates a side sectional view of a system including the case of FIG. 3 having received a portable electronic device and a battery device, in accordance with embodiments of the present disclosure.

FIG. 5 illustrates a perspective view of a top portion of a case with a chamber and a door in a closed configuration, in accordance with embodiments of the present disclosure.

FIG. 6 illustrates a perspective view of the top portion of the case of FIG. 5 with the door in an open configuration, in accordance with embodiments of the present disclosure.

FIG. 7 illustrates a sectional view of a case partially receiving a battery device, in accordance with embodiments of the present disclosure.

FIG. 8 illustrates a sectional view of the case of FIG. 7 fully receiving the battery device, in accordance with embodiments of the present disclosure.

FIG. 9 illustrates a sectional view of the case of FIGS. 7 and 8 releasing the battery device, in accordance with embodiments of the present disclosure.

FIG. 10 illustrates a side view of a system including a portable electronic device, a case, and a battery device, in accordance with embodiments of the present disclosure.

FIG. 11 illustrates a perspective view of a system including a case and a battery device, in accordance with embodiments of the present disclosure.

FIG. 12 illustrates a sectional view of the system of FIG. 11 including the case, the portable electronic device, and the battery device, in accordance with embodiments of the present disclosure.

FIG. 13 illustrates a block diagram of a system including a portable electronic device, a case, a battery device, and an external device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Portable electronic devices (e.g., wearable devices, mobile phones, media players, electronic watches, and the like) operate when there is charge stored in their batteries. Some portable electronic devices include a rechargeable battery that can be recharged by coupling the portable electronic device to a power source through a physical connection, such as through a charging cord. Using a charging cord to charge a battery in a portable electronic device, however, may require the portable electronic device to be physically tethered to a power outlet.

Certain electronic devices, such as wearable devices, can perform a range of functions that is determined by the components (e.g., sensors, circuitry, and other hardware) included with the wearable device as manufactured. However, space, cost, and other considerations may limit the ability to provide every component that might provide a desired function. For example, different users may have different preferences regarding the components and functions that are provided by a given external device. Some users may desire certain capabilities, such as high-resolution display and long battery life, while other users may desire other capabilities, such as smaller form factor. Furthermore, a given user may desire different functions at different times.

Given the diversity of desired components and functions, it would be beneficial to allow a user to select a battery device for use with an external device to extend and/or customize the user experience according to the user's desires. At the same time, the user may carry other portable electronic devices, such as a smartphone. It can be desirable to minimize the number of separate devices carried by a user.

Cases, such as those described herein, can couple to a battery device to be held within the case that also holds a portable electronic device. The case can hold the portable electronic device continually and receive the battery device when the user wants to group the devices together. The battery pack can provide charging power to the external device (e.g., wearable device) while held within the case. The case can provide engagement with the battery device to retain it and/or a communication link to communicate with it.

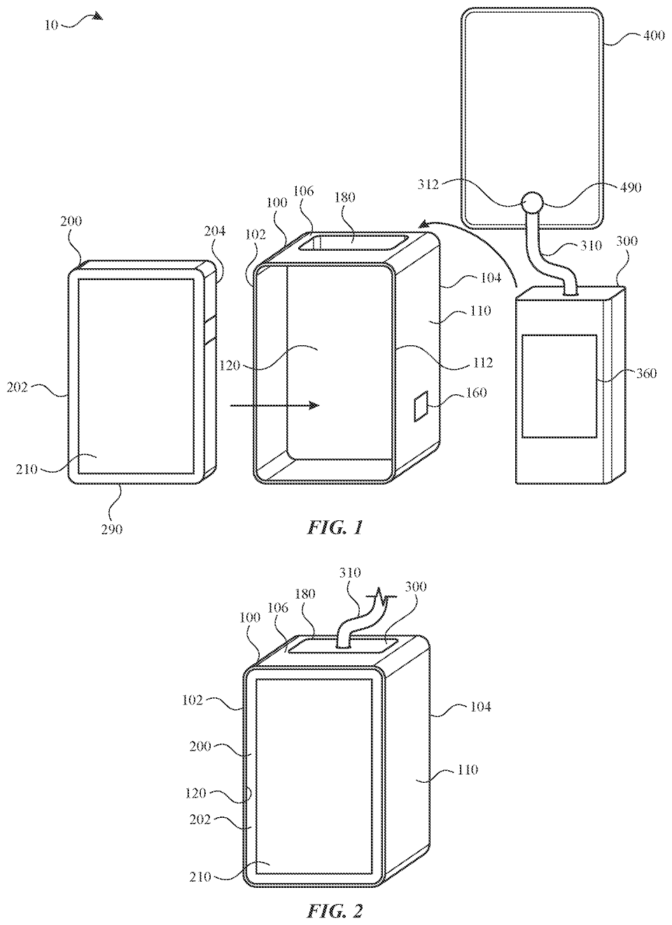

These and other embodiments are discussed below with reference to FIGS. 1-13. However, those skilled in the art will readily appreciate that the detailed description given herein with respect to these Figures is for explanatory purposes only and should not be construed as limiting.

Referring now to FIG. 1, a system 10 can include a case 100, a portable electronic device 200, and a battery device 300. The battery device 300 can be physically and/or operably connected or connectable to an external device 400 for providing functions thereto.

The portable electronic device 200 can be a device that is capable of operating independently of and/or in concert with the case 100. For example, the portable electronic device 200 may be a handheld or otherwise portable electronic device such as a smartphone, a portable media player, an internet-capable device, a personal digital assistant (“PDA”), any other electronic device, or any combination thereof. The electronic device 200 may be configured to provide specific features and/or applications for use by a user. The portable electronic device 200 may be a lightweight and small form factor device. For the sake of brevity, the portable electronic device 200 will not be described in detail. It should be appreciated, however, that the portable electronic device 200 may be embodied in a variety of forms including a variety of features, all or some of which can be utilized by the case 100 (e.g., input/output, controls, processing, battery, etc.).

The portable electronic device 200 can define a front side 202 and a rear side 204, opposite the front side 202. The portable electronic device 200 can include a display 210 on the front side 202 for viewing image-based content. Additionally, the portable electronic device 200 can include one or more input features on the front side 202 for receiving touch-based inputs from a user. The portable electronic device 200 can include a portable electronic device connector 290 that provides data and/or power communications between the portable electronic device 200 and another device. The communication interface provided by the connector may be wired or wireless.

The case 100 may be any device that couples to the portable electronic device 200 and/or the battery device 300. The case 100 may define or include a first chamber 120 for receiving and retaining the portable electronic device 200. The case 100 may further define or include a second chamber 180 for receiving and retaining the battery device 300.

The case 100 can define a front side 102 and a rear side 104, opposite the front side 102. A case housing 110 of the case 100 can receive at least the rear side 204 of the portable electronic device 200 through at least the front side 102 of the case 100. For example, the case housing 110 of the case 100 can provide a first chamber 120 into which a portion or the entirety of portable electronic device 200 may be placed. The first chamber 120 may be defined, at least in part, by sidewalls 112 of the case housing 110 that surround some portion of the portable electronic device 200 (e.g., exterior surfaces). In one example, the sidewalls 112 can be between the front side 102 and the rear side 104 of the case 100 and can extend about an entire periphery of the portable electronic device 200 that is between the front side 202 and the rear side 204 of the portable electronic device 200. The first chamber 120 may be further defined, at least in part, by a portion of the case housing 110 that provides a surface along the front side 102 of the case 100. The first chamber 120 may also include one or more retention features for holding and securing the portable electronic device within the first chamber 120. The retention features may include rails, channels, snaps, detents, latches, catches, magnets, friction couplings, doors, locks, flexures, and the like. It will be understood that coupling between the case 100 and the portable electronic device 200 can be secure, such that the case 100 and the portable electronic device 200 are not inadvertently separated during use. It will be further understood that the case 100 and the portable electronic device 200 can be removably coupled, such that the portable electronic device 200 can be removed from the case 100 as desired by a user. As such, the coupling between the case 100 and the portable electronic device 200 can be reversible, such that each can be restored to a state prior to any coupling there between.

The case 100 may further define or include a second chamber 180 for receiving and retaining at least a portion of the battery device 300. The case housing 110 of the case 100 can receive at least a portion of the battery device 300 through at least the top side 106 of the case 100. For example, the case housing 110 of the case 100 can provide a second chamber 180 into which a portion or the entirety of battery device 300 may be placed. The second chamber 180 may be defined, at least in part, by the case housing 110 that surround some portion of the battery device 300 (e.g., exterior surfaces). In one example, the case housing 110 can have portions between the front side 102 and the rear side 104 of the case 100 and can optionally extend about an entire periphery of the battery device 300. The second chamber 180 may be further defined, at least in part, by a portion of the case housing 110 that provides a surface along the rear side 104 of the case 100. The second chamber 180 may also include one or more retention features for holding and securing the portable electronic device within the second chamber 180, as described further herein. For example, the retention features may include rails, channels, snaps, detents, latches, catches, magnets, friction couplings, doors, locks, flexures, and the like. It will be understood that coupling between the case 100 and the battery device 300 can be secure, such that the case 100 and the battery device 300 are not inadvertently separated during use. It will be further understood that the case 100 and the battery device 300 can be removably coupled, such that the battery device 300 can be removed from the case 100 as desired by a user. As such, the coupling between the case 100 and the battery device 300 can be reversible, such that each can be restored to a state prior to any coupling there between.

The case 100 can include one or more case components 160 for controlling and/or performing one or more functions and/or operations of the case 100. Such functions and/or operations can relate to the portable electronic device 200, the battery device 300, and/or the external device 400 when such are directly and/or indirectly connected to the case 100, as described further herein.

In some embodiments, the battery device 300 can be a device that can be held or carried by a user. In some embodiments, the battery device 300 can be a wearable device that is worn optionally near the external device 400. The battery device 300 can be worn on a head, neck, ear, shoulders, and/or other portion of the user and/or the user's clothing (e.g., pocket). The battery device 300 can include a securement element to secure the battery device 300 to or near a user.

The external device 400 can be one or more of a variety of electronic devices. In some embodiments, the external device 400 can include wearable devices, such as watches, health monitoring devices, head-mountable devices, earpiece devices, and the like. In some embodiments, the external device 400 can include portable devices, such as smartphones, tablet computers, laptops, and the like. It will be understood that the external device 400 be one or more of a variety of devices, including one of multiple devices to which the battery device 300 can be connected at different occasions.

The external device 400 be provided with a connection to the attachable, removable, and/or exchangeable battery device 300, which can provide a variety of different components and functions to achieve the results that are desired by a user. As shown in FIG. 1, the battery device 300 can be separate from but connectable to the external device 400. The external device 400 can include one or more external device connectors 490 for mechanically and operably (e.g., communicatively) connecting to the battery device 300. The battery device 300 can include a tether 310 with a tether connector 312. The tether connector 312 can be configured to mechanically and operably (e.g., communicatively) connect to the external device 400 via the external device connector 490. Attachment can be achieved with an engagement that holds the tether connector 312 of the battery device 300 in place relative to the external device 400 until release (e.g., by the user). In some embodiments, while the tether connector 312 engages the external device connector 490, the tether connector 312 can rotate with respect to the battery device 300 while maintaining engagement therewith and/or a communication link. Such rotation can help relieve torque applied at the interface between the tether connector 312 and the external device connector 490. In some embodiments, while the tether connector 312 engages the external device connector 490, the tether connector 312 can maintain a fixed position and/or orientation with respect to the battery device 300.

The external device 400 can be provided with one or more battery devices 300 for further enhancing functionality of the external device 400. While a single battery device 300 is shown, it will be understood that the description herein can apply to any number of battery devices 300 simultaneously or alternately connected to the external device 400.

The battery device 300 can include one or more battery device components 360 that provide functions to the external device 400 when connected thereto, as described herein. An electrical or other communication connection can be made and maintained upon mechanical securement of the external device connectors 490 and the tether connector 312, for example via corresponding communication interfaces. When the external device 400 is connected to the battery device 300, components of both can be in operative communication with each other. For example, components of the battery device 300 can be in operative communication with components of the external device 400.

It will be understood that the external device 400 can be operable with or without use of the battery device 300 and that the battery device 300 can provide additional functionality to the external device 400 when installed. Connection of a battery device 300 with an external device 400 can be performed and reversed, followed by disconnection and connection of another battery device 300 with the same external device 400 or another external device 400 with the same battery device 300. As such, multiple battery devices 300 can be exchangeable with each other with respect to a given external device 400. Further, multiple external devices 400 can be exchangeable with each other with respect to a given battery device 300.

A battery device 300 can be connected to an external device 400 in a manner that allows the battery device 300 to be removed thereafter. The connection can be fully reversible, such that when the battery device 300 and the external device 400 are disconnected, each is restored to a condition held prior to the connection. The connection can be fully repeatable, such that after the battery device 300 and the external device 400 are disconnected, the same or a different external device 400 and battery device 300 pair can be connected in the same way. The battery device 300 and external device 400 can be securely and temporarily connected, rather than permanently, fixedly, or resiliently connected (e.g., via chemical and/or molecular bond). For example, connection and disconnection of the battery device 300 and external device 400 are facilitated in a manner that does not cause permanent damage, harm, or deformation to the battery device 300 or the external device 400.

As shown in FIG. 2, The case 100, the portable electronic device 200, and the battery device 300 can be separate devices that are temporarily and securely coupled together to form an integrated unit, which can be compactly stowed. As shown, the portable electronic device 200 can be stored in the first chamber 120 of the case 100, and the battery device 300 can be stored in the second chamber 180 of the case 100. In such an arrangement, the tether 310 of the battery device 300 can continue to extend to an external device (not shown in FIG. 2). As an integrated unit, the case 100, the portable electronic device 200, and the battery device 300 can remain together so the user has fewer separate objects to gather and maintain. Instead, the user can easily transport and store the integrated system.

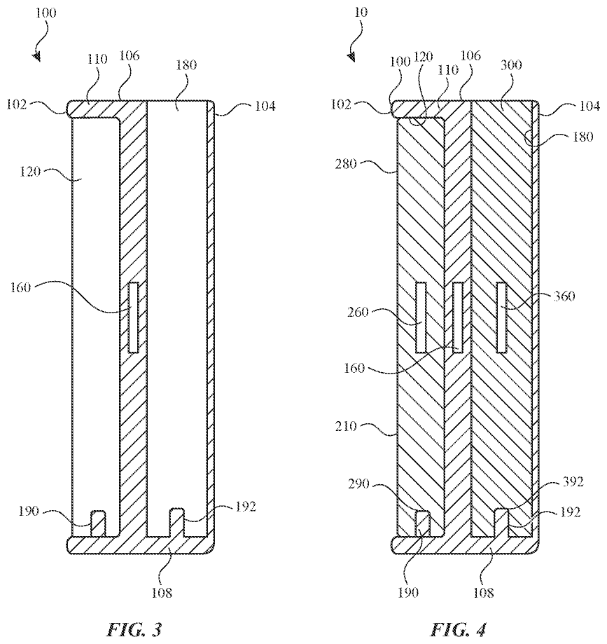

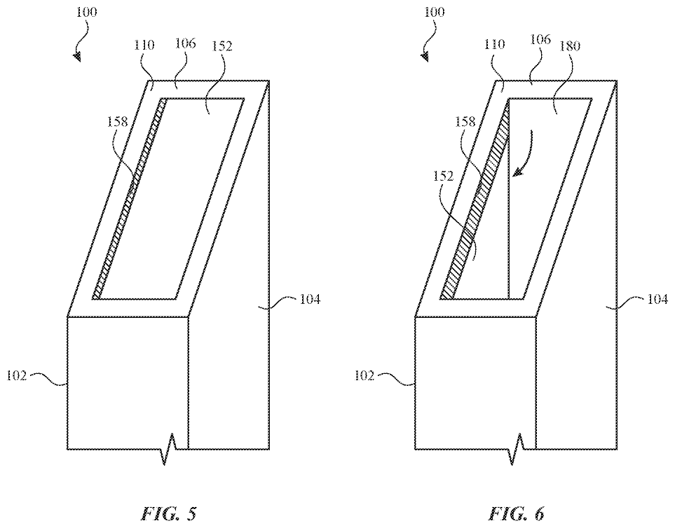

Referring to FIGS. 3 and 4, a case can be provided with chambers to mechanically and/or operatively couple to each of a portable electronic device and a battery device.

As shown in FIG. 3, the case 100 can include a first case connector 190 at or near that first chamber 120 that mates with and/or facilitates a communication link with a portable electronic device when the portable electronic device is placed within the first chamber 120. As further shown in FIG. 3, the case 100 can include a second case connector 192 at or near that second chamber 180 that mates with and/or facilitates a communication link with a battery device when the battery device is placed within the second chamber 180.

As shown in FIG. 4, the first chamber 120 of the case 100 can receive and retain a portable electronic device 200, and the second chamber 180 of the case 100 can receive and retain a battery device 300. The first case connector 190 of the case 100 can mate with and/or facilitate a communication link with the portable electronic device 200 via a portable electronic device connector 290 when the portable electronic device 200 is placed within the first chamber 120. The second case connector 192 of the case 100 can mate with and/or facilitate a communication link with the battery device 300 via a battery device connector 392 when the battery device 300 is placed within the second chamber 180.

As further shown in FIG. 4, the case 100 can include a case component 160 for controlling and/or performing one or more functions and/or operations of the case 100. For example, the case component 160 can include control circuitry that directs electrical activity through, from, and/or to the case 100. In some embodiments, the case components 160 is for controlling and/or performing one or more functions and/or operations of the case 100. Such functions and/or operations can relate to the portable electronic device 200, the battery device 300, and/or the external device 400 when such are directly and/or indirectly connected to the case 100, as described further herein. In some embodiments, the case component 160 can include circuitry that is electrically, communicatively, and/or operatively connected to the first case connector 190 and/or the second case connector 192 to control communications between the case 100 and the portable electronic device 200 and/or the battery device 300, respectively. For example, the portable electronic device 200 can include a portable electronic device component 260 that is operatively connected to the case component 160 via the portable electronic device connector 290 and/or the first case connector 190. By further example, the battery device 300 can include a battery device component 360 that is operatively connected to the case component 160 via the battery device connector 392 and/or the second case connector 192. By further example, through the electronic circuitry of the case component 160, the portable electronic device component 260 can also be operatively connected to the battery device component 360 and or components of the external device (not shown in FIG. 4).

In some embodiments, the case component 160 can comprise a battery that can operate with the battery of the battery device 300. For example, while the battery device 300 can provide battery power to other devices of the system 10, the case component 160 can also provide a battery that can receive power from the battery device 300 and/or provide power to other devices of the system 10.

In some embodiments, the case component 160 can actively control transfer of power among the case 100, the portable electronic device 200, the battery device 300, and/or the external device. For example, the case component 160 can include electrical circuitry that manages power based on the need for and availability of power (e.g., battery charge) among the interconnected devices. Such management can include transferring power to a device that have relatively little power, is using power at a high rate, and/or is predicted to need or use power in the future (e.g., based on historical activity).

In some embodiments, where the case component 160 interacts with the portable electronic device 200 and/or the battery device 300, the case component 160 can provide information to a user regarding the status of the case 100, the portable electronic device 200, the battery device 300, and/or the external device. For example, the case component 160 can comprise an input and/or output device that provides a user interface configured to provide a notification based on an activity of the case 100, the portable electronic device 200, the battery device 300, and/or the external device. Such activity can include a status (e.g., battery charge status) of any of the devices, power transfer between the devices, and/or other detectable conditions. Based on such output information, the user can make decisions about how to arrange and operate the devices of the system 10.

It will be understood that the devices of the system need not be operatively, communicatively, and/or controllably connected to each other. The system 10 can optionally be assembled without accomplishing some, all, or any of the communication interfaces described herein with respect to some embodiments.

Referring now to FIGS. 5 and 6, a case can provide a door for providing selective access to a chamber thereof. As shown in FIG. 5, the case 100 can include a door 152 that, in at least one configuration, covers a chamber of the case 100. In a close configuration of the door 152, the chamber can be covered so that it is isolated from an external environment. This can prevent or reduce the ingress of debris into the chamber while such a chamber is not occupied, for example by a battery device.

As shown in FIG. 6, the door 152 can move to provide access to the second chamber 180. For example, the door 152 can be pivotably coupled to the case housing 110 of the case 100. As a battery device (not shown) is inserted into the second chamber 180, the door 152 can move to permit passage of the battery device. The door 152 can remain in such a configuration while the battery device remains within the second chamber 180 and/or until the battery device is removed from the second chamber 180.

While the door 152 is shown pivotably coupled to the case housing 110 via a hinge 158, it will be understood that a variety of connections can be provided. For example, the door 152 can be configured to slide, roll, compress, collapse, and/or deform to selectively prevent or provide access to the second chamber 180. By further example, multiple doors 152 can be provided at any given opening providing selective access to the second chamber 180. While the doors 152 are shown at a top side 106 of the case 100, it will be understood that the opening to the second chamber 180 can be provided on any side (e.g., front side 102, rear side 104, and/or other side) of the case 100. As such, the corresponding door 152 can be provided as desired for access on the corresponding side.

In some embodiments, the door 152 can be biased to a closed position, such that, in the absence of a battery device, the door 152 can cover the second chamber 180. Such a bias can be overcome by inserting the battery device into the second chamber 180 through abutment against the door 152. Where such advice is provided, the door 152 can return to the closed position upon removal of the battery device. Such a bias can be provided by the hinge 158 and/or another mechanism that acts on the door 152.

Referring now to FIGS. 7-9, a case can provide engagement with a battery device to help retain the battery device within the case until released by a user. As shown in FIG. 7, battery device 300 can be provided within a second chamber 180 of a case 100, as defined by the case housing 110 thereof. The case 100 can be provided with one or more case engagers 130 for interacting with one or more battery device engagers 330 of the battery device 300.

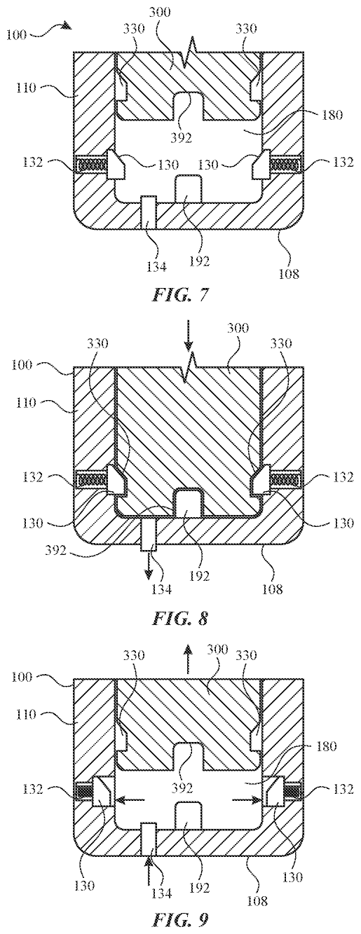

As shown in FIG. 8, as the battery device 300 is fully inserted into the second chamber 180 (e.g., towards the bottom side 108), the case engagers 130 can interact with the battery device engagers 330. For example, the case engagers 130 can include latches that are each configured to engage a corresponding detent (e.g., as the battery device engagers 330) of the battery device 300. Each of the latches can be biased to engaging position by one or more springs 132. Such a biasing can be overcome as the battery device 300 is inserted into the second chamber 180, for example by acting on a ramp or other portion of the latches to move them enough to permit passage of the battery device 300. Upon full insertion of the battery device 300, the latches can move into the detents of the battery device by action of the springs 132. In some embodiments, the latches can retain the battery device 300 in its fully inserted position until released therefrom. For example, the shape of the latches can prevent reverse motion of the battery device until the latches are removed from the detents. In some embodiments, the latches are released by manual actuation from a user (e.g., with the ejector 134). In some embodiments, the latches are released when the reverse force of the battery device 300 on the latches exceeds a threshold.

As further shown in FIG. 8, full insertion of the battery device 300 into the second chamber 180 can also bring the second case connector 192 of the case 100 into engagement with the battery device connector 392 of the battery device 300. Additionally or alternatively, an ejector 134 of the case 100 can be actuated by full insertion of the battery device 300 into the second chamber 180. For example, as shown in FIG. 8, the battery device 300 can optionally act directly on the ejector 134 to move it partially out and beyond the case housing 110 of the case 100. Actuation of the ejector 134 can help make the ejector 134 more accessible and/or readily available to a user for further actuation, as described further herein.

As shown in FIG. 9, the battery device 300 can be removed from the second chamber 180. For example, the user can actuate the ejector 134, which can directly and/or indirectly act on the battery device 300. Additionally or alternatively, actuation of the ejector 134 can actuate the case engagers 130 to be retracted away from the battery device 300 and the battery device engagers 330 thereof. For example, the ejector 134 can be directly coupled to the latches, such that actuation of the ejector causes a corresponding motion of the latches to move away from the detents of the battery device 300. As the battery device 300 is at least partially ejected from the second chamber 180, the user can grasp a protruding portion of the battery device 300 and removed the remainder from the second chamber 180.

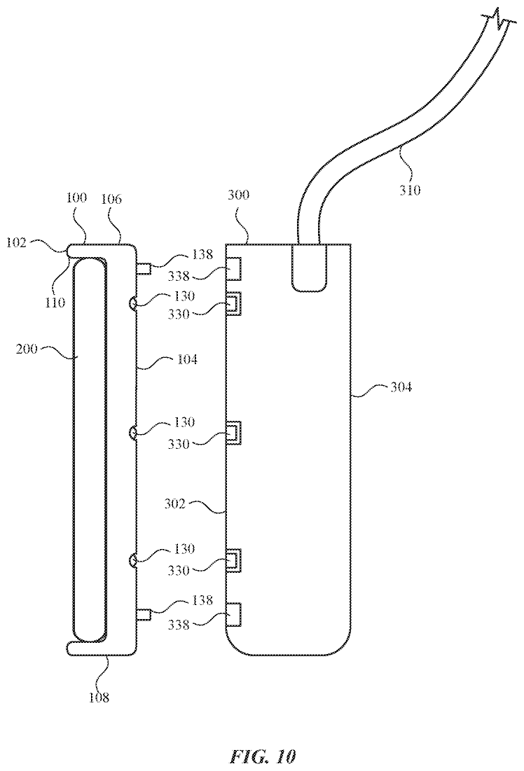

Referring now to FIG. 10, battery device can be engaged to a case by one or more of a variety of different engagement mechanisms. For example, as shown in FIG. 10, a battery device 300 can be directly coupled to a side of a case, even when no chamber is provided for reception of the battery device 300. Retention of the battery device 300 with respect to the case 100 can be provided by corresponding engagers. For example, in some embodiments, the case engagers 130 and the battery device engagers 330 can include magnets that are configured to magnetically attract and couple to each other. When the battery device 300 is brought into sufficiently close proximity of the case 100, the magnets of the case 100 can magnetically attract and coupled to the magnets of the battery device 300. Such engagement can maintain the battery device 300 in a couple configuration with respect to the case 100 until separated by sufficiently large force.

In some embodiments, additional engagement components can be provided. For example, while the magnets can urge the battery device and the case 100 towards each other, other mechanisms can limit shearing movement of the battery device 300 with respect to the case 100. For example, as further shown in FIG. 10, the case 100 can include one or more protrusions 138, and the battery device 300 can include one or more recesses 338. By positioning the protrusions 138 within the recesses 338, lateral movement of the battery device 300 relative to the case 100 (e.g., shearing movement) can be limited. It will be understood that protrusions in recesses can be positioned on either and/or both of the case 100 and the battery device 300.

It will be understood that one or more of a variety of engagement mechanisms can be provided. For example, the case engagers 130 and/or the battery device engagers 330 can include rails, channels, snaps, detents, latches, catches, magnets, friction couplings, doors, locks, flexures, and the like.

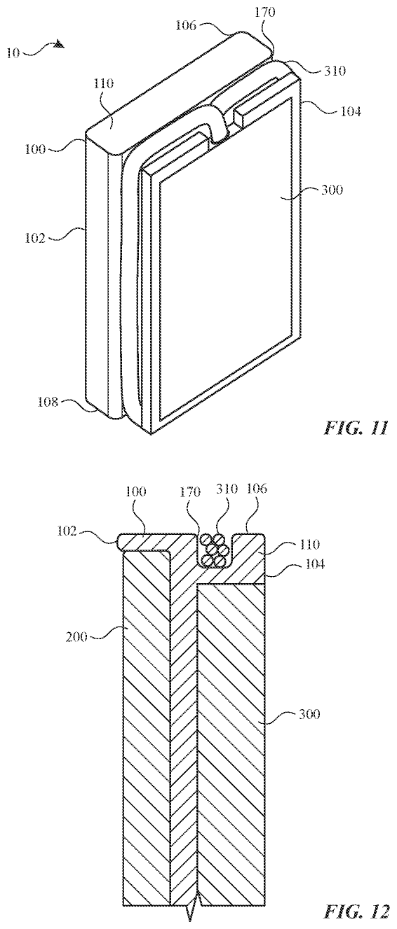

Referring now to FIGS. 11 and 12, a case can provide retention mechanisms for a tether of a battery device. As shown in FIG. 11, while the battery device 300 is coupled to a case 100, the tether 310 of the battery device can be stored when not connected to an external device (not shown). For example, the tether 310 can be stored within a channel 170 defined by the case housing 110 of the case 100.

As shown in FIG. 12, as the tether 310 extends from a body of the battery device 300, it can wrap around a portion of the case 100 such as through the channel 170. The tether 310 can wrap with as many windings as is necessary to capture a sufficient length of the tether 310. The channel 170 can extend about a periphery of the case 100, such as with a cutout portion that extends continuously to form a full loop of open space inset within walls of the case housing 110. Additionally or alternatively, the channel can be formed of discontinuous portions through which the continuous tether 310 can extend. The case 100 can engage the tether connector (not shown) to secure against the case 100. For example, the case 100 can provide a connector that is similar to the external device connectors 490. The tether connector can be configured to mechanically connect to the case 100, and such attachment can be achieved with an engagement that holds the tether connector 312 of the battery device 300 in place relative to the case 100 until release (e.g., by the user).

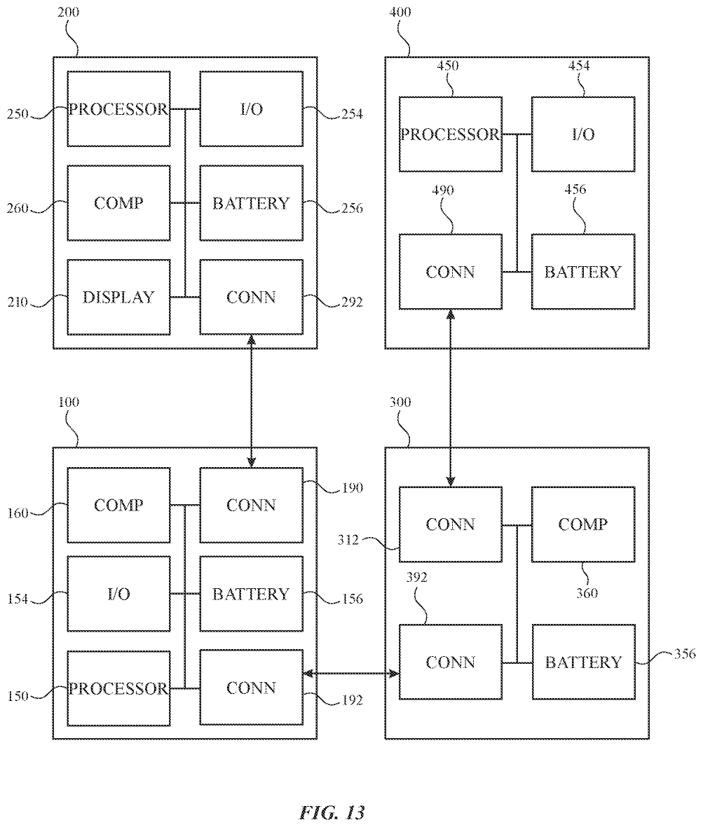

FIG. 13 illustrates a block diagram of a system including a portable electronic device, a case, a battery device, and an external device, in accordance with some embodiments of the present disclosure. It will be appreciated that components described herein can be provided on any one or more of the portable electronic device, the case, the battery device, and the external device. In some embodiments, components are provided by one or some of the portable electronic device, the case, the battery device, and the external device instead of each and every one of the portable electronic device, the case, the battery device, and the external device to reduce redundancy and increase customization, for example based on a selection of a battery device.

The case 100, the portable electronic device 200, the battery device 300, and/or the external device 400 can include a processor (e.g., processors 150, 250, and/or 350) with one or more processing units that include or are configured to access a memory having instructions stored thereon. The instructions or computer programs may be configured to perform one or more of the operations or functions described with respect to the corresponding device. The processor can be implemented as any electronic device capable of processing, receiving, or transmitting data or instructions. For example, the processor may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements. The memory can store electronic data that can be used by the external device 400. For example, the memory can store electrical data or content such as, for example, audio and video files, documents and applications, device settings and user preferences, timing and control signals or data for the various modules, data structures or databases, and so on. The memory can be configured as any type of memory. By way of example only, the memory can be implemented as random access memory, read-only memory, Flash memory, removable memory, or other types of storage elements, or combinations of such devices.

The case 100, the portable electronic device 200, the battery device 300, and/or the external device 400 a battery (e.g., batteries 156, 256, 356, and/or 456). Such batteries can store power for use by the corresponding device and/or for transfer to another connected device, as described herein.

The case 100, the portable electronic device 200, the battery device 300, and/or the external device 400 can include an input/output component (e.g., I/O components 154, 254, and/or 454), which can include any suitable component for providing a user interface for operation by a user. The input/output component can include buttons, keys, touchscreens, microphones, speakers, displays, and/or another feature that can be operated by the user. The input and/or the output can be tactile, auditory, visual, and the like.

Where any of the case 100, the portable electronic device 200, the battery device 300, and the external device 400 are connected with a communications interface, such devices can communicate with each other and/or one or more other devices using any suitable communications protocol. For example, the first case connector 190, the second case connector 192, the portable electronics device connector 292, the battery device connector 390, the tether connector 312, and/or the external device connector 490 can include a communications interface that supports Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. A communications interface can also include an antenna for transmitting and receiving electromagnetic signals. Such interfaces (e.g., via connectors) can transmit power, signals, commands, and the like.

In some embodiments, the battery device 300 can operate as a power source for the external device 400. By providing power with a removable battery device, the user can select such a battery device according to anticipated power needs. The battery 356 can include a battery that is used to store and provide power to the external device 400, the battery device 300, the portable electronic device, and/or the case 100. Optionally, the battery device 300 can recharge the battery 456 of the external device 400, the battery 256 of the portable electronic device 200, and/or the battery 156 of the case 100, for example, by directing power from the battery 356 across the corresponding connectors. Other pathways are contemplated, such as another link or wireless charging. As such, power transfer can be wired and/or wireless. The battery can be a replaceable battery, a rechargeable battery.

Other components of the various devices can add functions and/or operations to other connected devices. For example, the case component 160 of the case 100, the portable electronic device component 260 of the portable electronic device 200, the battery device component 360 of the battery device 300, and/or the external device component 460 of the external device 400 can be or include one or more of a variety of electronic components that are operable with or without connection to another device. For example, one or more components can include speakers, cameras, microphones, environment sensors, bio-sensors, user sensors, displays, input devices, display drivers, and the like. Each of the case 100, the portable electronic device 200, the battery device 300, and/or the external device 400 can include any number of components. By providing components on separate devices, the user can optionally provide an appropriate device when selected functions are desired. At other times, other devices or no device can be selected, thereby reducing the need to have all features available at all times.

The case 100 can provide an output to a user based on an action relating to the portable electronic device 200, the battery device 300, and/or the external device 400. For example, the case 100 can provide an output upon attachment and/or removal of the battery device 300 with respect to the case 100. By further example, the case 100 can provide an output upon detection of a user input provided at the portable electronic device 200. The output provided by the case 100 can include a confirmation relating to an operation and/or condition (e.g., installed, absent, active, inactive, charged, etc.) of the battery device 300. The output provided by the case 100 can include a prompt relating to an action for the user to perform. The output can be provided according to the operation of the processor 150 of the case 100 and produce by one or more components of the case 100 that is operably connected to the processor 150.

Additionally or alternatively, the case 100 can alter one or more parameters of its operations based on the presence, absence, or other condition of the portable electronic device 200, the battery device 300, and/or the external device 400. For example, when the battery device 300 is installed, the case 100 may perform an action the utilized the functions of the battery device 300. By further example, when the battery device 300 is absent, the case 100 may perform an action that does not rely on the functions of the battery device 300. Additionally or alternatively, the case 100 may perform actions in a manner that consumes power based on the presence, absence, and/or amount of power provided by a battery device 300. For example, the case 100 can perform an action with greater power consumption (e.g., high-resolution display output, enhanced audio and/or imaging processing, communication with battery devices) when a battery of the battery device 300 is present and sufficiently charged, and the case 100 can perform an action with lower power consumption (e.g., low-resolution display output, reduced audio and/or imaging processing, reduced communication with battery devices) or refrain from performing such an action when a battery of the battery device 300 is absent or not sufficiently charged.

The battery device 300 can be configured to interact with at least one other device other than the external device 400 and/or the case 100. For example, the battery device 300 can be charged by an external device with a power source, so that the battery 356 of the battery device 300 carries a charge for transfer to the external device 400 and/or the case 100.

Accordingly, embodiments of the present disclosure provide a case that facilitates operation with a portable electronic device and a battery device that can be connected to another, external device. To minimize the number of separate devices carried by a user, a battery device can be held within the case that also holds the portable electronic device. The case can hold the portable electronic device continually and receive the battery device when the user wants to group the devices together. The battery pack can provide charging power to the external device (e.g., wearable device) while held within the case. The case can provide engagement with the battery device to retain it and/or a communication link to communicate with it.

Various examples of aspects of the disclosure are described below as clauses for convenience. These are provided as examples, and do not limit the subject technology.

Clause A: a system comprising: a battery device comprising: a battery; a tether for operably connecting the battery to an external device for power transfer between the battery to the external device; and a battery device engager; and a case comprising: a case housing for receiving a portable electronic device; and a case engager configured to couple the battery device to the case when the case engager interacts with the battery device engager.

Clause B: a case for a portable electronic device and a battery device, the case comprising: a case housing defining a first chamber on a first side of the case housing for receiving the portable electronic device and a second chamber on a second side of the case housing, opposite the first side, for receiving the battery device; and a case engager configured to engage the battery device to releasably retain the battery device within the second chamber while the battery device is connected to an external device.

Clause C: a case for a portable electronic device and a battery device, the case comprising: a case housing defining a first chamber for receiving the portable electronic device and a second chamber for receiving the battery device; control circuitry; and a connector for operably connecting the battery device to the control circuitry while the battery device is within the second chamber and connected to an external device.

One or more of the above clauses can include one or more of the features described below. It is noted that any of the following clauses may be combined in any combination with each other, and placed into a respective independent clause, e.g., Clause A, B, or C.

Clause 1: each of the battery device engager and the case engager comprises magnets.

Clause 2: one of the battery device engager and the case engager comprises a latch, and the other of the battery device engager and the case engager comprises a detent.

Clause 3: the case comprises an ejector configured to, when actuated, to release the battery device from the case.

Clause 4: one of the battery device engager and the case engager comprises a protrusion, and the other of the battery device engager and the case engager comprises a recess, such that the battery device is prevented from moving across a surface of the case when the battery device is coupled to the case.

Clause 5: the case housing forms a chamber configured to surround a side portion and a rear portion of the portable electronic device while leaving a front portion of the portable electronic device exposed when the portable electronic device is received within the chamber.

Clause 6: the tether comprises a tether connector that is configured to engage the external device with a rotational engagement.

Clause 7: the battery device further comprises a battery device connector; and the case further comprises a case connector configured to connect to the battery device connector when the battery device is coupled to the case to provide a communication link between the battery device and the case.

Clause 8: a door pivotably coupled to the case housing to cover the second chamber in a first configuration and extend into the second chamber in a second configuration.

Clause 9: the case engager comprises a latch configured to engage a detent of the battery device.

Clause 10: the case comprises an ejector configured to, when actuated, release the battery device from the case engager.

Clause 11: the case comprises an ejector configured to, when actuated, move the battery device at least partially out of the second chamber.

Clause 12: the case housing defines a channel extending about a periphery of the case housing, the channel being between the first side and the second side for receiving a tether of the battery device.

Clause 13: the first chamber is configured to surround a side portion and a rear portion of the portable electronic device while leaving a front portion of the portable electronic device exposed when the portable electronic device is received within the first chamber.

Clause 14: a case connector configured to connect to a battery device connector of the battery device when the battery device is coupled to the case to provide a communication link between the battery device and the case.

Clause 15: a user interface configured to provide a notification based on an activity of the battery device.

Clause 16: the control circuitry is configured to control power transfer between the portable electronic device, the battery device, and the external device.

Clause 17: an additional battery within the case housing and configured to be electrically connected to the battery device through the connector while the battery device is within the second chamber.

As described above, one aspect of the present technology may include the gathering and use of data. The present disclosure contemplates that in some instances, this gathered data may include personal information or other data that uniquely identifies or can be used to locate or contact a specific person. The present disclosure contemplates that the entities responsible for the collection, disclosure, analysis, storage, transfer, or other use of such personal information or other data will comply with well-established privacy policies and/or privacy practices. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item, rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A system comprising:
a battery device comprising:
a battery;
a tether for operably connecting the battery to an external device for power transfer between the battery to the external device; and
a battery device engager; and
a case comprising:
a case housing for receiving a portable electronic device; and
a case engager configured to couple the battery device to the case when the case engager interacts with the battery device engager.

2. The system of claim 1, wherein each of the battery device engager and the case engager comprises magnets.

3. The system of claim 1, wherein one of the battery device engager and the case engager comprises a latch, and the other of the battery device engager and the case engager comprises a detent.

4. The system of claim 1, wherein the case comprises an ejector configured to, when actuated, to release the battery device from the case.

5. The system of claim 1, wherein one of the battery device engager and the case engager comprises a protrusion, and the other of the battery device engager and the case engager comprises a recess, such that the battery device is prevented from moving across a surface of the case when the battery device is coupled to the case.

6. The system of claim 1, wherein the case housing forms a chamber configured to surround a side portion and a rear portion of the portable electronic device while leaving a front portion of the portable electronic device exposed when the portable electronic device is received within the chamber.

7. The system of claim 1, wherein the tether comprises a tether connector that is configured to engage the external device with a rotational engagement.

8. The system of claim 1, wherein:
the battery device further comprises a battery device connector; and
the case further comprises a case connector configured to connect to the battery device connector when the battery device is coupled to the case to provide a communication link between the battery device and the case.

9. A case for a portable electronic device and a battery device, the case comprising:
a case housing defining a first chamber on a first side of the case housing for receiving the portable electronic device and a second chamber on a second side of the case housing, opposite the first side, for receiving the battery device; and
a case engager configured to engage the battery device to releasably retain the battery device within the second chamber while the battery device is connected to an external device.

10. The case of claim 9, further comprising a door pivotably coupled to the case housing to cover the second chamber in a first configuration and extend into the second chamber in a second configuration.

11. The case of claim 9, wherein the case engager comprises a latch configured to engage a detent of the battery device.

12. The case of claim 9, wherein the case comprises an ejector configured to, when actuated, release the battery device from the case engager.

13. The case of claim 9, wherein the case comprises an ejector configured to, when actuated, move the battery device at least partially out of the second chamber.

14. The case of claim 9, wherein the case housing defines a channel extending about a periphery of the case housing, the channel being between the first side and the second side for receiving a tether of the battery device.

15. The case of claim 9, wherein the first chamber is configured to surround a side portion and a rear portion of the portable electronic device while leaving a front portion of the portable electronic device exposed when the portable electronic device is received within the first chamber.

16. The case of claim 9, further comprising a case connector configured to connect to a battery device connector of the battery device when the battery device is coupled to the case to provide a communication link between the battery device and the case.

17. A case for a portable electronic device and a battery device, the case comprising:
a case housing defining a first chamber for receiving the portable electronic device and a second chamber for receiving the battery device;
control circuitry; and
a connector for operably connecting the battery device to the control circuitry while the battery device is within the second chamber and connected to an external device.

18. The case of claim 17, further comprising a user interface configured to provide a notification based on an activity of the battery device.

19. The case of claim 17, wherein the control circuitry is configured to control power transfer between the portable electronic device, the battery device, and the external device.

20. The case of claim 17, further comprising an additional battery within the case housing and configured to be electrically connected to the battery device through the connector while the battery device is within the second chamber.
